(19) United States
(12) Patent Application Publication
(10) Pub. No.: US 2024/0319722 A1
(43) Pub. Date: Sep. 26, 2024

(54) EQUIPMENT STATE MONITOR DEVICE, EQUIPMENT STATE MONITORING METHOD, AND COMPUTER-READABLE MEDIUM

(71) Applicant: Mitsubishi Electric Corporation, Tokyo (JP)

(72) Inventors: Toshiyuki KURIYAMA, Tokyo (JP); Koji WAKIMOTO, Tokyo (JP)

(73) Assignee: Mitsubishi Electric Corporation, Tokyo (JP)

(21) Appl. No.: 18/734,723

(22) Filed: Jun. 5, 2024

Related U.S. Application Data
(63) Continuation of application No. PCT/JP2022/003912, filed on Feb. 2, 2022.

(51) Int. Cl. G05B 23/02

(52) U.S. Cl. CPC G05B 23/0254

(57) ABSTRACT

An equipment state monitor device includes: a feature value extraction unit that extracts feature value data regarding a state of equipment that is an object to be monitored, from operation data indicating the state of the equipment; a data conversion unit that converts the feature value data extracted from the operation data into determination data in a feature value space that does not depend on an operation pattern of the equipment in an operation environment in which the state of the equipment is monitored; a determination unit that determines the state of the equipment on the basis of a result of comparison between the determination data and the feature value distribution indicating a determination range in the feature value space; and an output unit that outputs a result of determining the state of the equipment.

### CROSS REFERENCE TO RELATED APPLICATIONS

This application is a Continuation of PCT International Application No. PCT/JP2022/003912, filed on Feb. 2, 2022, which is hereby expressly incorporated by reference into the present application.

### TECHNICAL FIELD

The present disclosure relates to an equipment state monitor device, an equipment state monitoring method, and computer-readable medium.

### BACKGROUND ART

A state of equipment such as a machine tool generally changes depending on an operation environment and an operation condition of the equipment. Therefore, a technique of inferring a state of equipment using a learning model specialized for an operation environment and an operation condition of the equipment has been proposed. For example, a server device described in Patent Literature 1 selects a shared model suitable for an operation environment or an operation condition of a target device from a plurality of shared models that have learned in advance in accordance with operation environments and operation conditions of various devices, and performs additional learning of the selected shared model using device data acquired from the target device as non-learning data. The shared model is a general-purpose learning model, but is finely adjusted as a learning model corresponding to the operation environment or the operation condition of the target device by performing additional learning in the operation environment and the operation condition specialized for the target device.

### CITATION LIST

### Patent Literature

Patent Literature 1: JP 2020-161167 A

### SUMMARY OF INVENTION

### Technical Problem

When a state of equipment operated in an operation pattern specified by an operation condition varies, a feature value distribution of operation data indicating the state of the equipment spreads, and a determination accuracy of the state of the equipment is lowered. In the conventional technique described in Patent Literature 1, a plurality of shared models suitable for various operation patterns is used in such a manner as not to lower determination accuracy of a state of equipment operated in each operation pattern (operation condition). Note that the shared model has not performed learning in an operation environment and an operation condition specialized for target equipment, and a state of equipment cannot be determined with high accuracy. Therefore, in the conventional technique described in Patent Literature 1, additional learning of the shared model is performed using data obtained from the target equipment.

However, learning data used for the additional learning of the shared model is data in an operation environment different from learning data used for generating the shared model even when the learning data is obtained from the target equipment. Therefore, since an inference result of the shared model that has performed additional learning inevitably includes an error factor due to a difference in operation environment, a state of equipment cannot be accurately determined. That is, in the method for selecting a model to be used for determining a state of equipment from a plurality of general-purpose shared models prepared in advance, there is a problem that the state of the equipment cannot be accurately determined.

The present disclosure solves the above problem, and an object thereof is to obtain an equipment state monitor device and an equipment state monitoring method capable of determining a state of equipment without selecting a general-purpose learning model and performing additional learning.

### Solution to Problem

An equipment state monitor device according to the present disclosure includes: processing circuitry to extract feature value data regarding a state of equipment that is an object to be monitored, from operation data indicating the state of the equipment, to convert the feature value data extracted from the operation data into determination data in a feature value space that does not depend on an operation pattern in an operation environment, and to determine the state of the equipment on a basis of a comparison between the determination data and a feature value distribution indicating a determination range in the feature value space; and an output interface to output a result of determining the state of the equipment.

### Advantageous Effects of Invention

According to the present disclosure, feature value data extracted from operation data indicating a state of equipment that is an object to be monitored is converted into determination data in a feature value space that does not depend on an operation pattern of the equipment in an operation environment in which the state of the equipment is monitored, and that specifies a feature value distribution indicating a determination range of the state of the equipment, and the state of the equipment is determined on the basis of a result of comparison between the determination data and the feature value distribution indicating the determination range in the feature value space. Since the state of the equipment is determined with reference to the determination range that does not depend on the operation pattern in the operation environment in which the state of the equipment is monitored, the equipment state monitor device according to the present disclosure can determine the state of the equipment without selecting a general-purpose learning model and performing additional learning.

### BRIEF DESCRIPTION OF DRAWINGS

FIG. 1 is a block diagram illustrating a configuration of an equipment state monitor device according to a first embodiment.

FIG. 2 is a flowchart illustrating an equipment state monitoring method according to the first embodiment.

FIG. 3A is an explanatory diagram illustrating a feature value distribution regarding a state of equipment in each operation pattern, and FIG. 3B is an explanatory diagram illustrating a feature value distribution of a normal range and a feature value distribution of an abnormal range of the state of the equipment in a feature value space that does not depend on the operation pattern.

FIGS. 4A and 4B are each a block diagram illustrating a hardware configuration for implementing a function of the equipment state monitor device according to the first embodiment.

FIG. 5 is a block diagram illustrating a configuration of an equipment state monitor device according to a second embodiment.

FIG. 6 is a flowchart illustrating an equipment state monitoring method according to the second embodiment.

FIG. 7 is a graph illustrating a relationship between an operation data feature value and an operation pattern command value of equipment in different operation environments.

FIG. 8 is an explanatory diagram illustrating an outline of generation of a feature value distribution in a feature value space that does not depend on an operation pattern.

### DESCRIPTION OF EMBODIMENTS

### First Embodiment

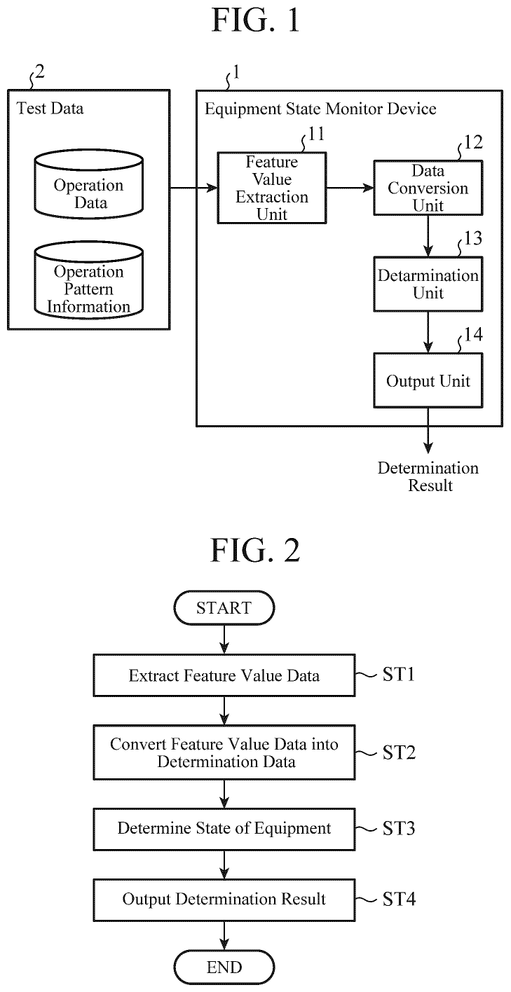

FIG. 1 is a block diagram illustrating a configuration of an equipment state monitor device 1 according to a first embodiment. In FIG. 1, the equipment state monitor device 1 is a device that monitors a state of equipment that is an object to be monitored, using operation data acquired from the equipment. Examples of the equipment that is an object to be monitored, include a machine tool such as a rotary machine. The operation data is data indicating the state of the equipment, and is, for example, time-series data of a measurement value indicating the state of the equipment measured from the equipment operating in a certain operation pattern. The operation pattern is a series of operations performed by the equipment, and is executed by the equipment in which an operation pattern command value for instructing each of the operations is set. Examples of the operation pattern command value include a command speed, a command position, and a command load.

As illustrated in FIG. 1, the equipment state monitor device 1 is connected to a storage device 2 that stores test data. The test data is data in which operation data of equipment that is an object to be monitored, is associated with operation pattern information indicating an operation pattern of the equipment when the operation data is acquired. For example, operation data and operation pattern information measured by a sensor attached to equipment that is an object to be monitored or a control device that controls operation of the equipment that is an object to be monitored are stored in the storage device 2 as test data. The equipment state monitor device 1 determines a state of the equipment that is an object to be monitored, using the test data read from the storage device 2.

The equipment state monitor device 1 includes a feature value extraction unit 11, a data conversion unit 12, a determination unit 13, and an output unit 14. The feature value extraction unit 11 extracts feature value data regarding the state of the equipment that is an object to be monitored, from operation data indicating a state of the equipment. For example, the feature value extraction unit 11 receives, as an input, operation data of the equipment measured for each constant measurement cycle from a sensor or a control device, and calculates a feature value of the input operation data for each measurement cycle. The operation data feature value is, for example, a statistic such as an average value, a minimum value, a maximum value, or a variance of the operation data measured within a time of the measurement cycle, or a power spectrum obtained by performing a fast Fourier transform (FFT).

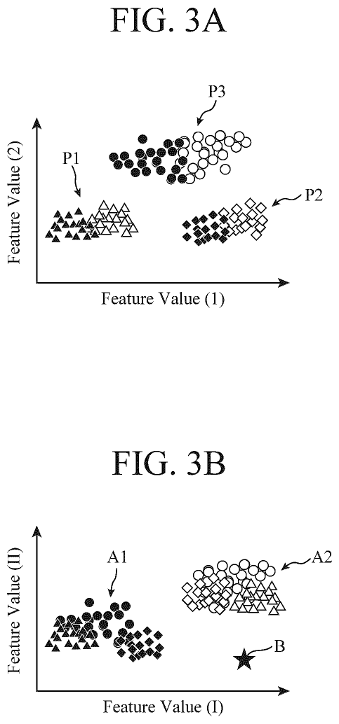

The data conversion unit 12 converts the feature value data extracted from the operation data by the feature value extraction unit 11 into determination data in a feature value space that does not depend on an operation pattern of the equipment in a certain operation environment. The feature value space specifies a feature value distribution indicating a determination range of the state of the equipment that does not depend on an operation pattern of the equipment. In addition, as described later with reference to FIG. 3, the feature value distribution indicating the determination range of the state of the equipment is calculated on the basis of tendencies of a plurality of feature value distributions regarding the state of the equipment operated in a plurality of operation patterns in a certain operation environment.

For example, one distribution generated by determining a plurality of feature value distributions regarding an abnormal state of the equipment operated in each of a plurality of operation patterns in a certain operation environment, and converting (bringing close) a positional relationship among the feature value distributions in such a manner that a distance between centers of the distributions is minimized is a feature value distribution indicating an abnormal range of the equipment that does not depend on the operation pattern. Similarly for a normal range of the equipment, one distribution generated by determining a plurality of feature value distributions regarding a normal state of the equipment operated in each of a plurality of operation patterns, and converting a positional relationship among the feature value distributions in such a manner that a distance between centers of the distributions is minimized is a feature value distribution indicating a normal range of the equipment that does not depend on the operation pattern.

In the feature value distributions respectively corresponding to the operation patterns of the equipment, by applying, to each feature value, conversion for causing feature values classified into the same state of the equipment to approach each other, the feature value distribution indicating a determination range of the state of the equipment in a feature value space that does not depend on the operation pattern is generated. The data conversion unit 12 converts the feature value data extracted from the operation data into data in a feature value space, that is, performs so-called data projection into the feature value space using, for example, a conversion equation representing conversion of a feature value. The data projected into the feature value space is determination data used for determining the state of the equipment.

The feature value distribution indicating a determination range of the state of the equipment in a feature value space that does not depend on an operation pattern may be obtained by applying, to a feature value, conversion in which a distance between a distribution of feature values classified into a certain state and a distribution of feature values classified into a state different from the certain state is increased in a plurality of feature value distributions respectively corresponding to a plurality of operation patterns of the equipment. Also in this case, the data conversion unit 12 can convert the feature value data extracted from the operation data into data in the feature value space using the conversion equation of the feature value.

The determination unit 13 determines the state of the equipment on the basis of a result of comparison between the determination data and the feature value distribution indicating the determination range in the feature value space. For example, when the determination data is included in the feature value distribution indicating the determination range of the state of the equipment in the feature value space, the determination unit 13 determines that the state of the equipment is a state of the equipment indicated by the determination range. Meanwhile, when the determination data is not included in the feature value distribution indicating the determination range of the state of the equipment, the determination unit 13 determines that the state of the equipment is not a state of the equipment indicated by the determination range.

In addition, the determination range of the state of the equipment in the feature value space that does not depend on an operation pattern may be achieved by a machine learning model. The machine learning model is, for example, a learning model that receives, as an input, the feature value data extracted from the operation data of the equipment by the feature value extraction unit 11 and infers the state of the equipment on the basis of the determination range. The determination unit 13 inputs the determination data converted by the data conversion unit 12 to the learning model, and outputs an inference result of the state of the equipment by the learning model as a determination result of the state of the equipment.

The output unit 14 outputs the determination result of the state of the equipment. The determination result output by the output unit 14 is used for monitoring the state of the equipment. For example, the output unit 14 outputs display control information for displaying the feature value space, the determination range, and the determination result to a display device disposed separately from the equipment state monitor device 1. The display device displays the feature value space, the determination range, and the determination result on the basis of the display control information. Note that the output unit 14 may be included in an external device disposed separately from the equipment state monitor device 1.

FIG. 2 is a flowchart illustrating an equipment state monitoring method according to the first embodiment, and illustrates an operation of the equipment state monitor device 1. The feature value extraction unit 11 acquires operation data indicating a state of equipment that is an object to be monitored, from the storage device 2, and extracts feature value data regarding the state of the equipment from the acquired operation data (step ST1). For example, the feature value extraction unit 11 extracts time-series data of the feature value regarding the state of the equipment for each measurement cycle from the operation data read from the storage device 2. The extracted time-series data of the feature value is output to the data conversion unit 12 as the feature value data.

Next, the data conversion unit 12 converts the feature value data extracted from the operation data of the equipment into determination data in a feature value space that does not depend on an operation pattern of the equipment (step ST2). FIG. 3A is an explanatory diagram illustrating feature value distributions regarding states of equipment operating in operation patterns P1, P2, and P3. In FIG. 3A, a feature value (1) and a feature value (2) are feature value data regarding the states of the equipment operating in the operation patterns P1, P2, and P3. For example, in a case where the equipment is a rotary machine and the state of the equipment is a rotation state of the rotary machine, an average value of torque is set as the feature value (1) regarding the rotation state, and a standard deviation of torque is set as the feature value (2) regarding the rotation state.

In the feature value distribution regarding the state of the equipment operated in the operation pattern P1, a black triangular plot indicates a feature value classified into an abnormal range among feature values regarding the state of the equipment, and a white triangular plot indicates a feature value classified into a normal range. In the feature value distribution regarding the state of the equipment operated in the operation pattern P2, a black circular plot indicates a feature value classified into an abnormal range among feature values regarding the state of the equipment, and a white circular plot indicates a feature value classified into a normal range. In the feature value distribution regarding the state of the equipment operated in the operation pattern P3, a black rhombic plot indicates a feature value classified into an abnormal range among feature values regarding the state of the equipment, and a white rhombic plot indicates a feature value classified into a normal range.

As illustrated in FIG. 3A, in a boundary portion between the normal range and the abnormal range of each of the feature value distributions corresponding to the operation patterns P1 to P3, some plots indicating a feature value classified into the normal range and some plots indicating a feature value classified into the abnormal range overlap each other. In addition, for example, some plots classified into one determination range are present in a region where many plots classified into the other determination range are present. These plots are plots indicating feature values when the state of the equipment transitions from the normal range to the abnormal range, or indicating feature values including variations in the state of the equipment for each operation pattern. As described above, when the feature values are classified into the normal range and the abnormal range in the feature value distribution for each operation pattern, ambiguity of classification occurs at a boundary portion between the normal range and the abnormal range. This ambiguity also occurs, for example, in a learning model that has learned a determination range of the state of the equipment for each operation pattern, and is a factor by which the determination accuracy of the state of the equipment by the learning model is lowered.

FIG. 3B is an explanatory diagram illustrating a feature value distribution A1 of an abnormal range and a feature value distribution A2 of a normal range of a state of equipment in a feature value space that does not depend on an operation pattern. In FIG. 3B, the feature value distribution A1 of the abnormal range and the feature value distribution A2 of the normal range are calculated by applying, to each feature value, conversion in which the feature values classified into the abnormal range approach each other and the feature values classified into the normal range approach each other in the feature value distributions corresponding to the operation patterns P1, P2, and P3.

For example, a center of the black triangular feature value distribution corresponding to the operation pattern P1 is represented by C1, a center of the black rhombic feature value distribution corresponding to the operation pattern P2 is represented by C2, and a center of the black circular feature value distribution corresponding to the operation pattern P3 is represented by C3. In this case, the feature value distribution A1 of the abnormal range and the feature value distribution A2 of the normal range are calculated by applying, to each feature value, conversion in which a distance L1 between C1 and C2 is minimized, a distance L2 between C1 and C3 is minimized, and a distance L3 between C2 and C3 is minimized.

As described above, the feature value distribution A1 of the abnormal range is a distribution reflecting a tendency of the feature value distribution classified into the abnormal range corresponding to the operation patterns P1, P2, and P3, the feature value distribution A2 of the normal range is a distribution reflecting a tendency of the feature value distribution classified into the normal range corresponding to the operation patterns P1, P2, and P3, and both are feature value distributions in a feature value space that does not depend on the operation pattern.

In addition, the feature value distribution A1 of the abnormal range and the feature value distribution A2 of the normal range can be calculated by converting a feature value in such a manner that a distance between a feature value classified into the abnormal range and a feature value classified into the normal range is increased in the feature value distributions corresponding to the operation patterns P1 to P3.

The feature value (I) and the feature value (II) in FIG. 3B are feature values obtained by reflecting, in the feature value (1) and the feature value (2), conversion of a feature value performed when the feature value distribution A1 of the abnormal range and the feature value distribution A2 of the normal range are calculated.

Note that, although the case has been described in which both the feature value distribution A1 of the abnormal range and the feature value distribution A2 of the normal range are calculated in the feature value space that does not depend on the operation patterns P1 to P3, either the feature value distribution A1 of the abnormal range or the feature value distribution A2 of the normal range may be calculated.

The determination unit 13 determines the state of the equipment that is an object to be monitored on the basis of a result of comparison between determination data B converted by the data conversion unit 12 and the feature value distribution A1 of the abnormal range or the feature value distribution A2 of the normal range (step ST3). Here, the determination unit 13 determines whether or not the state of the equipment is close to the normal state on the basis of a positional relationship between the determination data B and the feature value distribution A1 of the abnormal range or the feature value distribution A2 of the normal range. For example, when a distance L4 between the determination data B and a distribution center C4 of the feature value distribution A1 of the abnormal range is less than a threshold, it is determined that the state of the equipment indicated by the determination data B is in the abnormal range and the equipment is in the abnormal state. In addition, when the distance L4 between the determination data B and the distribution center C4 of the feature value distribution A1 of the abnormal range is equal to or more than the threshold, and a distance L5 between the determination data B and a distribution center C5 of the feature value distribution A2 of the normal range is less than the threshold, the equipment is determined to be in the normal state.

In addition, by assuming that a deterioration state of the equipment is a state between the state of the equipment classified into the normal range and the state of the equipment classified into the abnormal range, the determination unit 13 may determine that the equipment is in the deterioration state depending on the distances L4 and L5.

The output unit 14 outputs a determination result of the state of the equipment (step ST4). The output unit 14, for example, displays a feature value space, a feature value distribution indicating a determination range in the feature value space, and the determination data B on a screen of the display device. As a result, a user can find the state of the equipment by visually recognizing the screen of the display device.

Functions of the feature value extraction unit 11, the data conversion unit 12, the determination unit 13, and the output unit 14 in the equipment state monitor device 1 are implemented by a processing circuitry. That is, the equipment state monitor device 1 includes a processing circuitry for executing processes in step ST1 to step ST4 in FIG. 2. The processing circuitry may be dedicated hardware or a central processing unit (CPU) that executes a program stored in a memory.

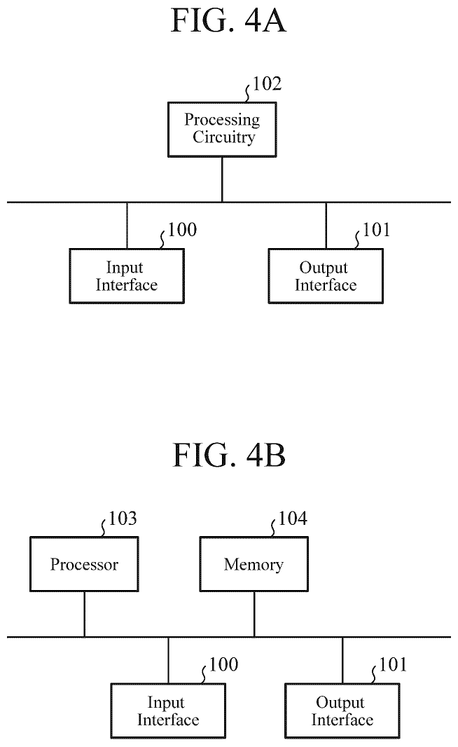

FIG. 4A is a block diagram illustrating a hardware configuration for implementing a function of the equipment state monitor device 1. FIG. 4B is a block diagram illustrating a hardware configuration for executing software for implementing the function of the equipment state monitor device 1. In FIGS. 4A and 4B, an input interface 100 is an interface that relays operation data read from the storage device 2 by the equipment state monitor device 1. An output interface 101 is an interface that relays information indicating a determination result of the state of the equipment output from the equipment state monitor device 1.

In a case where the processing circuitry is a processing circuitry 102 of dedicated hardware illustrated in FIG. 4A, for example, a single circuit, a composite circuit, a programmed processor, a parallel programmed processor, an application specific integrated circuit (ASIC), a field-programmable gate array (FPGA), or a combination thereof corresponds to the processing circuitry 102.

The functions of the feature value extraction unit 11, the data conversion unit 12, the determination unit 13, and the output unit 14 in the equipment state monitor device 1 may be implemented by separate processing circuitries, or these functions may be collectively implemented by one processing circuitry.

In a case where the processing circuitry is a processor 103 illustrated in FIG. 4B, the functions of the feature value extraction unit 11, the data conversion unit 12, the determination unit 13, and the output unit 14 in the equipment state monitor device 1 are implemented by software, firmware, or a combination of software and firmware. Note that software or firmware is described as a program and stored in a memory 104.

The processor 103 implements the functions of the feature value extraction unit 11, the data conversion unit 12, the determination unit 13, and the output unit 14 in the equipment state monitor device 1 by reading and executing a program stored in the memory 104. For example, the equipment state monitor device 1 includes the memory 104 for storing a program that causes processes in steps ST1 to ST4 in the flowchart illustrated in FIG. 2 to be executed as a result when the program is executed by the processor 103. These programs cause a computer to execute procedures or methods performed by the feature value extraction unit 11, the data conversion unit 12, the determination unit 13, and the output unit 14.

The memory 104 may be a computer-readable storage medium storing a program for causing a computer to function as the feature value extraction unit 11, the data conversion unit 12, the determination unit 13, and the output unit 14.

To the memory 104, for example, a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disc, a compact disc, a mini disc, a DVD, or the like corresponds.

Some of the functions of the feature value extraction unit 11, the data conversion unit 12, the determination unit 13, and the output unit 14 in the equipment state monitor device 1 may be implemented by dedicated hardware, and the remaining functions may be implemented by software or firmware.

For example, the functions of the feature value extraction unit 11, the data conversion unit 12, and the determination unit 13 are implemented by the processing circuitry 102 that is dedicated hardware, and the function of the output unit 14 is implemented by the processor 103 reading and executing a program stored in the memory 104. In this way, the processing circuitry can implement the above functions by hardware, software, firmware, or a combination thereof.

In the equipment state monitor device 1 or the equipment state monitoring method according to the first embodiment, the feature value extraction unit 11 extracts feature value data regarding a state of equipment that is an object to be monitored, from operation data indicating the state of the equipment, the data conversion unit 12 converts the feature value data extracted from the operation data into data in a feature value space that does not depend on an operation pattern of the equipment in an operation environment in which the state of the equipment is monitored, and that specifies a feature value distribution indicating a determination range of the state of the equipment, the determination unit 13 determines the state of the equipment on the basis of a result of comparison between the data converted by the data conversion unit 12 and a feature value distribution indicating the determination range in the feature value space, and the output unit 14 outputs a result of determining the state of the equipment.

Since the state of the equipment is determined with reference to the determination range that does not depend on the operation pattern in the operation environment in which the state of the equipment is monitored, the equipment state monitor device 1 can determine the state of the equipment without selecting a general-purpose learning model and performing additional learning.

### Second Embodiment

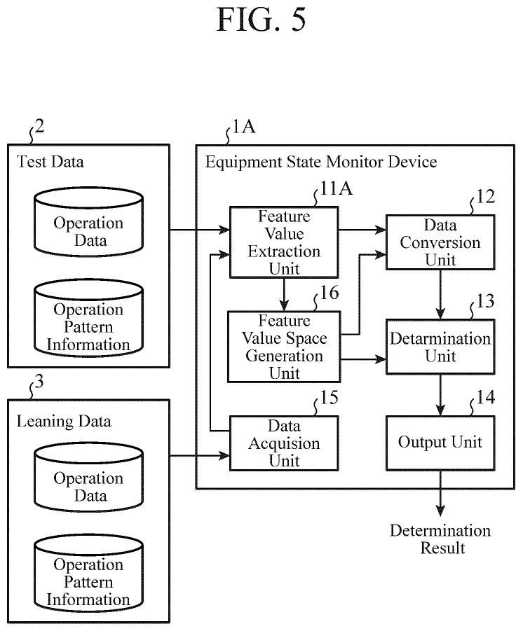

FIG. 5 is a block diagram illustrating a configuration of an equipment state monitor device 1A according to a second embodiment. In FIG. 5, the same components as those in FIG. 1 are denoted by the same reference numerals, and description thereof is omitted. The equipment state monitor device 1A generates a learning model for determining a state of equipment that is an object to be monitored, using learning data stored in a storage device 3, and determines the state of the equipment using the learning model.

The learning data stored in the storage device 3 is data in which operation data of the equipment that is an object to be monitored is associated with operation pattern information indicating an operation pattern of the equipment when the operation data is acquired in an operation environment in which the state of the equipment is monitored. Note that the learning data includes operation data indicating a normal state and operation data indicating an abnormal state of the equipment that has operated in the same operation pattern.

The equipment state monitor device 1A includes a feature value extraction unit 11A, a data conversion unit 12, a determination unit 13, an output unit 14, a data acquisition unit 15, and a feature value space generation unit 16. Similarly to the feature value extraction unit 11, the feature value extraction unit 11A extracts feature value data (operation data feature value) from operation data of the equipment stored as test data in a storage device 2. In addition, the feature value extraction unit 11A sequentially receives, as an input, operation data of the equipment acquired from the storage device 3 by the data acquisition unit 15, and extracts an operation data feature value of the equipment from the input operation data.

The data acquisition unit 15 comprehensively collects a plurality of pieces of operation data indicating a state of the equipment operated in a plurality of operation patterns in an operation environment in which the state of the equipment is monitored, regardless of the operation pattern. For example, in the storage device 3, a plurality of pieces of operation data indicating the state of the equipment operated in a plurality of operation patterns in an operation environment in which the state of the equipment is monitored is stored as learning data used for learning of a learning model for determining the state of the equipment. The data acquisition unit 15 comprehensively collects the operation data of the equipment stored in the storage device 3, regardless of the operation pattern.

The feature value space generation unit 16 generates a learning model for determining the state of the equipment using, as learning data, the plurality of pieces of feature value data extracted from the plurality of pieces of operation data collected by the data acquisition unit 15. The learning model is, for example, a machine learning model that receives, as an input, the feature value data extracted from the operation data and outputs an inference result of the state of the equipment on the basis of a determination range in a feature value space that does not depend on an operation pattern of the equipment.

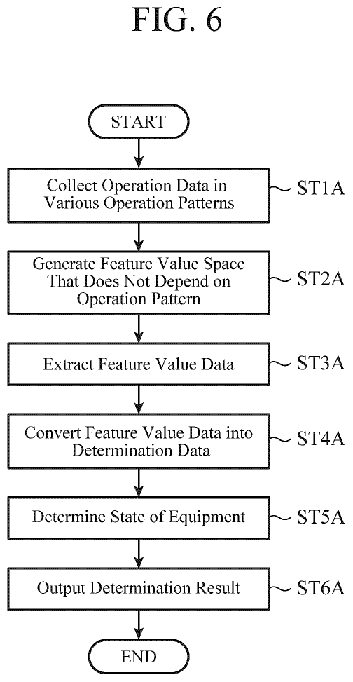

Note that functions of the feature value extraction unit 11A, the data conversion unit 12, the determination unit 13, the output unit 14, the data acquisition unit 15, and the feature value space generation unit 16 in the equipment state monitor device 1A are implemented by the processing circuitry illustrated in FIG. 4A or 4B. That is, the equipment state monitor device 1A includes a processing circuitry for executing processes in steps ST1A to ST6A illustrated in FIG. 6. The processing circuitry may be dedicated hardware or a processor for executing a program stored in a memory.

FIG. 6 is a flowchart illustrating an equipment state monitoring method according to the second embodiment, and illustrates an operation performed by the equipment state monitor device 1A. Note that processes in step ST3A to step ST6A illustrated in FIG. 6 are similar to the processes in step ST1 to step ST4 illustrated in FIG. 2. The data acquisition unit 15 comprehensively collects the operation data of the equipment stored in the storage device 3 regardless of the operation pattern (step ST1A). As a result, operation data in various operation patterns is collected.

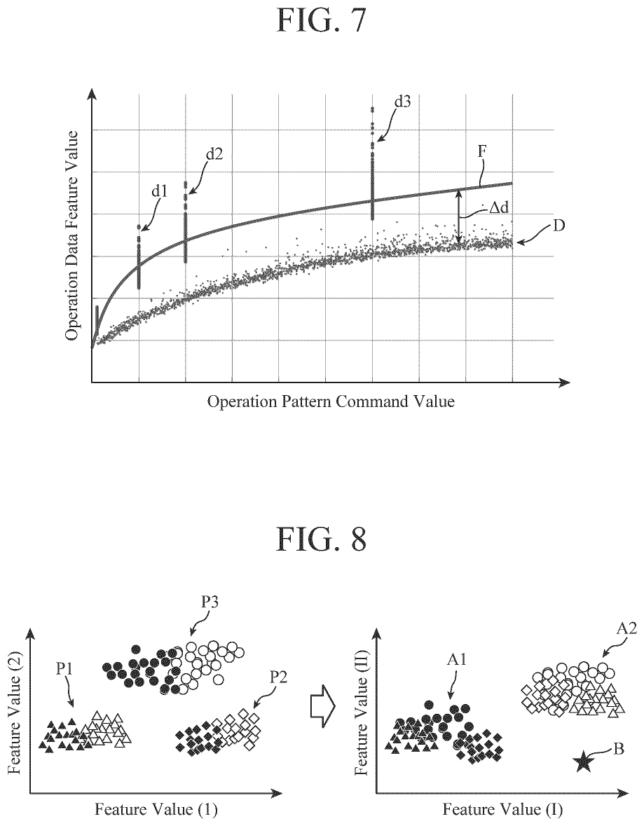

FIG. 7 is a graph illustrating a relationship between an operation data feature value and an operation pattern command value of the equipment in different operation environments. For example, in a case where the equipment that is an object to be monitored is a rotary machine and the rotary machine operates in an operation pattern including an operation of rotating a rotary mechanism at a constant speed, a relationship between a command speed value (operation pattern command value) for rotating the rotary mechanism at a constant speed and an average value (operation data feature value) of torque of the rotary mechanism rotated at the command speed value is represented by a monotonically increasing function.

In FIG. 7, an increase or decrease tendency of a feature value distribution (operation data feature value) extracted from the operation data indicating the state of the rotary machine operated in each of operation patterns d1, d2, and d3 is approximated by a monotonically increasing function F. It is assumed that an operation environment in which the feature value data is collected, for example, a collection month is December. In addition, it is assumed that a collection month of feature value data D comprehensively collected in various operation patterns regardless of individual operation patterns is, for example, March.

As illustrated in FIG. 7, there is a difference Δd between feature value data collected in December and feature value data collected in March. That is, even when the same equipment operates in the same operation pattern, different operation environments cause different states. Therefore, even in a case where a general-purpose learning model for determining the state of the equipment is generated for each operation pattern, when additional learning of the learning model is performed using operation data having different operation environments, determination accuracy of the learning model on which additional learning has been performed is lowered.

Therefore, the data acquisition unit 15 comprehensively collects the operation data of the equipment in an operation environment in which the state of the equipment is monitored, regardless of the operation pattern. The feature value extraction unit 11A sequentially receives, as an input, operation data of the equipment acquired from the storage device 3 by the data acquisition unit 15, and extracts feature value data regarding the state of the equipment from the input operation data. As a result, the feature value data D illustrated in FIG. 7 is acquired. The feature value data D includes a plurality of pieces of data corresponding to the same operation pattern command value, and includes data regarding a normal state of the equipment and data regarding an abnormal state of the equipment. Collection of the learning data by the data acquisition unit 15 may be repeatedly performed a predetermined number of times or may be performed once.

The feature value space generation unit 16 generates a learning model for determining the state of the equipment using, as learning data, the plurality of pieces of feature value data extracted from the plurality of pieces of operation data collected by the data acquisition unit 15 (step ST2A). FIG. 8 is an explanatory diagram illustrating an outline of generation of a feature value distribution in a feature value space that does not depend on an operation pattern. The left diagram of FIG. 8 illustrates feature value distributions regarding states of equipment operating in operation patterns P1, P2, and P3. As in FIG. 3A, a feature value (1) and a feature value (2) are feature value data regarding the states of the equipment operating in the operation patterns P1, P2, and P3.

By performing learning using the operation data feature value of the equipment, the feature value space generation unit 16 generates a learning model including feature values in the feature value space after conversion, corresponding to the operation patterns P1, P2, and P3, and a classification result into the normal state or the abnormal state. In the learning, the feature value space generation unit 16 receives, as an input, an index indicating the degree of progress of the learning as a loss function on the basis of the learning model. Here, as the index to be input as a loss function, an index L_{D} representing a distance between normal data distributions or abnormal data distributions in each operation pattern or an index L_{C} representing a difference between a correct answer label and a classification result is used. As the index L_{D} representing a distance between distributions, for example, a maximum mean discrepancy (MMD) is used. As the index L_{C} representing a difference between a correct answer label and a classification result, for example, a cross entropy loss is used.

For example, the feature value space generation unit 16 repeats a learning process of adjusting a coupling weighting coefficient or the like between nodes of each neural network in such a manner that the index L_{D} is minimized, that is, normal data distributions approach each other or abnormal data distributions approach each other in each pattern.

The feature value space generation unit 16 may repeat the learning process of adjusting a coupling weighting coefficient or the like between nodes of each neural network in such a manner that the index L_{C} is minimized, that is, a correct answer label and a classification result approach each other.

Furthermore, the feature value space generation unit 16 may repeat the learning process of adjusting a coupling weighting coefficient or the like between nodes of each neural network in such a manner that a sum of the index L_{C} and the index L_{D} is minimized.

Through the processing, as illustrated in the right diagram of FIG. 8, a learning model having the feature value distribution A1 indicating the abnormal range of the state of the equipment or a learning model having the feature value distribution A2 indicating the normal range is generated, regardless of the operation pattern. For example, a convolutional neural network (CNN) is used to generate the learning model.

The feature value extraction unit 11A extracts feature value data (operation data feature value) from operation data of the equipment stored as test data in the storage device 2 (step ST3A). The new feature value data extracted from the operation data by the feature value extraction unit 11A is input to the learning model by the data conversion unit 12, and converted into determination data B in a feature value space that does not depend on an operation pattern (step ST4A). The determination unit 13 determines the state of the equipment that is an object to be monitored, on the basis of a result of comparison between the determination data B converted by the data conversion unit 12 and the feature value distribution Al of the abnormal range or the feature value distribution A2 of the normal range (step ST5A). The output unit 14 outputs a determination result of the state of the equipment (step ST6A).

As described above, the equipment state monitor device 1A according to the second embodiment includes the data acquisition unit 15 and the feature value space generation unit 16 in addition to the feature value extraction unit 11A, the data conversion unit 12, the determination unit 13, and the output unit 14. The data acquisition unit 15 comprehensively collects a plurality of pieces of operation data indicating the state of the equipment regardless of an operation pattern. The feature value space generation unit 16 uses a plurality of pieces of feature value data extracted from the collected plurality of pieces of operation data as learning data, receives, as an input, the feature value data extracted from the operation data, and generates a learning model that infers the state of the equipment on the basis of a determination range. The determination unit 13 determines the state of the equipment using the learning model.

Since the state of the equipment is determined with reference to the determination range that does not depend on the operation pattern in the operation environment in which the state of the equipment is monitored, the equipment state monitor device 1A can determine the state of the equipment without selecting a general-purpose learning model and performing additional learning.

Note that the embodiments can be freely combined to each other, any component in each of the embodiments can be modified, or any component in each of the embodiments can be omitted.

### INDUSTRIAL APPLICABILITY

The equipment state monitor device according to the present disclosure can be used for monitoring a state of a machine tool, for example.

### REFERENCE SIGNS LIST

1 and 1A: Equipment state monitor device, 2 and 3: Storage device, 11 and 11A: Feature value extraction unit, 12: Data conversion unit, 13: Determination unit, 14: Output unit, 15: Data acquisition unit, 16: Feature value space generation unit, 100: Input interface, 101: Output interface, 102: Processing circuitry, 103: Processor, 104: Memory

What is claimed is:

1. An equipment state monitor device comprising:
processing circuitry
to extract feature value data regarding a state of equipment that is an object to be monitored, from operation data indicating the state of the equipment,
to convert the feature value data extracted from the operation data into determination data in a feature value space that does not depend on an operation pattern in an operation environment, and
to determine the state of the equipment on a basis of a comparison between the determination data and a feature value distribution indicating a determination range in the feature value space; and
an output interface to output a result of determining the state of the equipment.

2. The equipment state monitor device according to claim 1, wherein
the processing circuitry is configured:
to collect a plurality of pieces of the operation data indicating a state of the equipment operated in a plurality of the operation patterns in an operation environment, regardless of the operation pattern; and
to use, as learning data, a plurality of pieces of feature value data extracted from the plurality of pieces of operation data collected regardless of the operation pattern, to generate a learning model to infer the state of the equipment on a basis of the determination range, and
to determine the state of the equipment on a basis of the generated learning model.

3. The equipment state monitor device according to claim 1, wherein
the processing circuitry is configured to generate a learning model for determining the state of the equipment on a basis of the feature value space in which a plurality of the feature value data extracted from a plurality of the operation data are converted in such a way that, among the plurality of the feature value data extracted from the plurality of the operation data, normal data approach each other, and among the plurality of the feature value data extracted from the plurality of the operation data, abnormal data approach each other.

4. An equipment state monitoring method comprising:
extracting feature value data regarding a state of equipment that is an object to be monitored, from operation data indicating the state of the equipment;
converting the feature value data extracted from the operation data into determination data in a feature value space that does not depend on an operation pattern in an operation environment;
determining the state of the equipment on a basis of a comparison between the determination data and a feature value distribution indicating a determination range in the feature value space; and
outputting a result of determining the state of the equipment.

5. A non-transitory computer-readable medium having stored therein a program including instructions that, when executed by a processor, causes a computer to:
extract feature value data regarding a state of equipment that is an object to be monitored, from operation data indicating the state of the equipment;
convert the feature value data extracted from the operation data into determination data in a feature value space that does not depend on an operation pattern in an operation environment;
determine the state of the equipment on a basis of a comparison between the determination data and a feature value distribution indicating a determination range in the feature value space; and
output a result of determining the state of the equipment.
